(19) United States
(12) Patent Application Publication
(10) Pub. No.: US 2005/0017593 A1
(43) Pub. Date: Jan. 27, 2005

(54) Bobbin and motor

(76) Inventor: Yuzuru Suzuki, Shizuoka (JP)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 10/896,814

(22) Filed: Jul. 21, 2004

(30) Foreign Application Priority Data
Jul. 23, 2003 (JP) 2003-278652

(51) Int. Cl. H02K 3/46

(52) U.S. Cl. 310/194; 310/254

(57) ABSTRACT

In a motor comprising a stator assembly and a rotor assembly housed inside the stator assembly, a bobbin is structured to be oval-cylindrical in its radial cross section, rather than circular-cylindrical, such that a body section of the bobbin is composed of four continuous walls, two of which are formed of flat plates oriented perpendicular to the minor axis of the oval and disposed opposite to each other in parallel, and the other two of which are formed of outwardly arced plates oriented perpendicular to the flat walls and disposed opposite to each other in a symmetric manner. Pole teeth are provided only at portions corresponding to the arced walls to thereby reduce the dimension between the flat walls for downsizing while allowing an increased number of turns of a magnet wire wound around the bobbin.

### BACKGROUND OF THE INVENTION

1. Field of the Invention

The present invention relates to a bobbin having a magnet wire wound therearound, and further to a motor incorporating such a bobbin.

2. Description of the Related Art

FIG. 6 is a partly cross-sectional view of a conventional general stepping motor. The conventional motor basically comprises a rotor assembly 10, and a pair of stator units 20 and 30 which in combination constitute a stator assembly. The rotor assembly 10 is shaped substantially cylindrical, includes a permanent ring magnet having a plurality of magnetic poles 11 arranged on its circumferential surface, and has a rotary shaft 12 fixedly inserted through its center. The stator units 20 and 30 are both shaped substantially hollow-cylindrical like a doughnut, and are coupled to each other with their respective center openings coaxially aligned so as to rotatably house the rotor assembly 10 in the center openings.

The stator unit 20 is composed of yoke members 21 and 22 disposed so as to oppose each other, and a magnetic wire 23 wound around a bobbin 24 sandwiched between the yoke members 21 and 22. The yoke member 21 is shaped like a ring defining a center opening corresponding to the center opening of the stator unit 20, and a plurality of pole teeth 21a are formed along the inner circumference of the yoke member 21 and bent up so as to have their distal ends pointing toward the yoke member 22 and to be positioned to oppose the magnetic poles 11 of the rotor assembly 10. In a similar way, the yoke member 22 is shaped like a ring defining a center opening corresponding to the center opening of the stator unit 20, and a plurality of pole teeth 22a are formed along the inner circumference of the yoke member 22 and bent up so as to have their distal ends pointing toward the yoke member 21 and to be positioned to oppose the magnetic poles 11 of the rotor assembly 10. The bobbin 24 includes a body section shaped circular-cylindrical and two flanges disposed respectively at the ends of the body section, and the body section has an open hollow with a constant diameter. The pole teeth 21a and 22a of the yoke member 21 and 22 are inserted into the hollow of the body section of the bobbin 24 from respective ends thereof so as to intermesh with each other. An outer rim portion 22b of the yoke member 22 is bent, for example by drawing, toward the yoke member 21 so as to constitute an outer circumferential wall of the stator unit 20.

The stator unit 30 is composed of yoke members 31 and 32 structured and disposed like the above-described yoke members 21 and 22 of the stator unit 20, and a magnetic wire 33 (identical with the magnet wire 23) wound around a bobbin 34 (identical with the bobbin 24) sandwiched between the yoke members 31 and 32. An outer rim portion 32b of the yoke member 32 is bent up toward the yoke member 31 so as to constitute an outer circumferential wall of the stator unit 30.

With increasing demand for miniaturization of various devices, the above-described stepping motor incorporated therein is also requested to be downsized. If a motor is downsized in its axial direction for miniaturization, the distance between both bearings is inevitably decreased thus making it very difficult to control resulting problems such as wobbling of a rotor assembly, which hinders the productivity of reliable products. Consequently, there is a limit to the downsizing of a motor in the axial direction.

In the meanwhile, a motor may be downsized in its radial direction for miniaturization such that a rotor assembly has its radial dimension decreased, but the downsizing of a motor in the radial direction is approaching the limit in view of angular resolution and also torque characteristic. Under the circumstances, Japanese Patent Application KOKAI Publication No. H07-123686 discloses a motor for downsizing in the radial direction. The motor, if explained by using reference numerals shown in FIG. 6, comprises a stator assembly composed of stator units 20 and 30, in which an outer rim portions 22b and 32b of yoke members 22 and 32 constituting the outer circumferential walls have a reduced thickness thereby allowing magnet wires 23 and 33 to have an increased number of turns thus achieving an increased torque, or when the number of turns of the magnet wires 23 and 33 is not increased, the motor diameter can be reduced without detriment to the torque characteristic.

However, the motor disclosed by the aforementioned Japanese Patent Application KOKAI Publication No. H07-123686 has a problem that since the outer circumference walls of the stator units 20 and 30 constituted by the outer rim portions 22b and 32b of the yoke members 22 and 32 have a decreased thickness, the motor is weakened in mechanical strength thus resulting in deteriorated reliability against accidental external force. Thus, there still lies a limit to effort for downsizing.

### SUMMARY OF THE INVENTION

The present invention has been made in light of the circumstances described above, and it is an object of the present invention to downsize a motor while maintaining its torque characteristic.

In order to achieve the object, according to a first aspect of the present invention, a bobbin is provided which comprises:
a) a body section shaped hollow-cylindrical, having a predetermined length, and composed of
   a first wall formed of a flat rectangular plate,
   a second wall formed of a flat rectangular plate, and disposed to oppose the first wall in parallel,
   a third wall formed of a rectangular plate curved circumferentially outward, and having its both ends connected respectively to one end of the first wall and one end of the second wall, and
   a fourth wall formed of a rectangular plate curved circumferentially outward, disposed to symmetrically oppose the third wall, and having its both ends connected respectively to other end of the first wall and other end of the second wall;
b) a first flange disposed at one end of the body section so as to extend perpendicularly to the walls for a substantially uniform dimension, and
c) a second flange disposed at other end of the body section so as to extend perpendicularly to the walls for a substantially uniform dimension.

In the first aspect of the present invention, the third and fourth walls of the body section may have a circular arc radial cross-section, and a distance between the first and second walls may be smaller than a distance between the third and fourth walls.

Consequently, the bobbin according to the first aspect of the present invention has a reduced dimension at the first and second walls compared with the conventional structure, thus allowing dimensional reduction.

According to a second aspect of the present invention, a motor is provided which comprises
a) a rotor assembly shaped cylindrical, and having a ring magnet disposed at its outer circumference and provided with a predetermined number of magnetic poles, and a rotary shaft fixedly inserted through its center,
b) a stator assembly having
   a bobbin including
      a body section shaped hollow-cylindrical, having a predetermined length, and composed of: a first wall formed of a flat rectangular plate; a second wall formed of a flat rectangular plate, and disposed to oppose the first wall in parallel; a third wall formed of a rectangular plate curved circumferentially outward, and having its both ends connected respectively to one end of the first wall and one end of the second wall; and a fourth wall formed of a rectangular plate curved circumferentially outward, disposed to symmetrically oppose the third wall, and having its both ends connected respectively to other end of the first wall and other end of the second wall,
      a first flange disposed at one end of the body section so as to extend perpendicularly to the walls for a substantially uniform dimension, and
      a second flange disposed at other end of the body section so as to extend perpendicularly to the walls for a substantially uniform dimension,
   a magnet wire wound around the body section of the bobbin,
   a first yoke made of a soft magnetic steel plate, having at a center thereof an opening which defines an inner circumference of the first yoke, has a dimension larger than a diameter of the rotor assembly, corresponds to a hollow of the bobbin, and in which the rotor assembly is inserted, the first yoke having a plurality of pole teeth formed along the inner circumference thereof respectively at two portions corresponding to the third and fourth walls of the bobbin, the plurality of pole teeth being inserted in the hollow of the bobbin so as to oppose the magnetic poles of the rotor assembly,
   a second yoke made of a soft magnetic steel plate, disposed to oppose the first yoke so as to sandwich the bobbin therebetween, and having at a center thereof an opening which defines an inner circumference of the second yoke, has a dimension larger than the diameter of the rotor assembly, corresponds to the hollow of the bobbin, and in which the rotor assembly is inserted, the second yoke having a plurality of pole teeth formed along the inner circumference thereof respectively at two portions corresponding to the third and fourth walls of the bobbin, the plurality of pole teeth being inserted in the hollow of the bobbin so as to oppose the magnetic poles of the rotor assembly, and
   a magnetic path means to magnetically connect the first and second yokes, and
c) bearing means to rotatably support the rotary shaft of the rotor assembly such that a predetermined gap is kept between the magnetic poles of the rotor assembly and the pole teeth of the first and second yokes.

In the second aspect of the present invention, the third and fourth walls of the body section of the bobbin may have a circular arc radial cross-section, and a distance between the first and second walls may be smaller than a distance between the third and fourth walls.

In the second aspect of the present invention, the stator assembly may be composed of a plurality of stator units each constituted by the bobbin, the magnet wire, the first and second yokes, and the magnetic path means.

Consequently, the motor according to the second aspect of the present invention is allowed to have an increased number of turns of the magnet wire wound around the bobbin, whereby the dimensional reduction can be achieved without detriment to the motor characteristic.

### BRIEF DESCRIPTION OF THE DRAWINGS

FIG. 1 is an axial partly cross-sectional view of a stepping motor according to an embodiment of the present invention;

FIG. 2 is a perspective view of a bobbin of the stepping motor of FIG. 1;

FIG. 3 is an exploded perspective view of a stator unit of the stepping motor of FIG. 1;

FIG. 4A is an explanatory view of the bobbin and pole teeth in the stepping motor of FIG. 1;

FIG. 4B is an explanatory view of a bobbin and pole teeth in a conventional stepping motor;

FIG. 5 is a perspective view of a modification of a yoke; and

FIG. 6 is an axial partly cross-sectional view of a conventional stepping motor.

### DETAILED DESCRIPTION OF THE PREFERRED EMBODIMENT

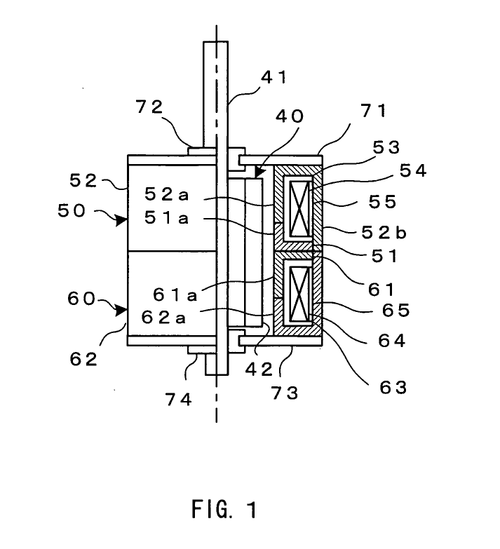

A preferred embodiment of the present invention will hereinafter be described with reference to FIG. 1 to FIGS. 4A and 4B.

Referring to FIG. 1, a stepping motor according to the embodiment is capable of two-phase driving, and comprises a rotor assembly 40 and two stator units 50 and 60 which in combination constitute a stator assembly.

The rotor assembly 40 is shaped cylindrical, and has a rotary shaft 41 fixedly inserted at its center and a ring magnet with a plurality of magnetic poles 42 at its outer circumference.

The stator unit 50 is composed of first and second yokes 51 and 52 disposed to oppose each other, and a magnet wire 54 wound around a bobbin 53 sandwiched between the first and second yokes 51 and 52, and an insulator 55 is disposed around the magnet wire 54.

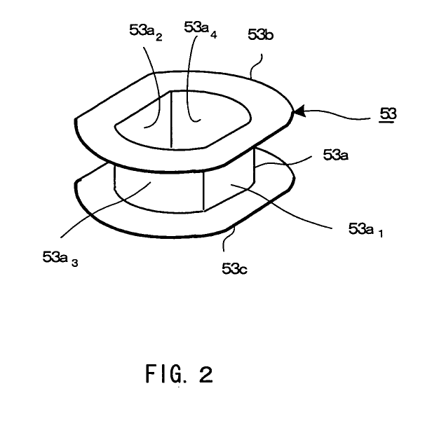

The bobbin 53 is formed of plastic resin or the like, and includes a body section 53a, and first and second flanges 53b and 53c as shown in FIG. 2. The body section 53a is composed of first, second, third and fourth walls 53a₁, 53a₂, 53a₃ and 53a₄ having a uniform and equal thickness, and shaped oval-cylindrical in its radial view rather than circular-cylindrical as conventionally, specifically such that the first and second walls 53a₁ and 53a₂ are rectangular and flat, and disposed to oppose each other in parallel, and that the third and fourth walls 53a₃ and 53a₄ are rectangular and arced outward, disposed so as to symmetrically oppose each other, have their one ends connected respectively to both ends of the first wall 53a₁, and have their respective other ends connected respectively to both ends of the second wall 53a₂. The first and second flanges 53b and 53c extend radially outward from respective ends of the body section 53a so as to form a radial cross-sectional outer configuration similar to and larger than that of the body section 53a.

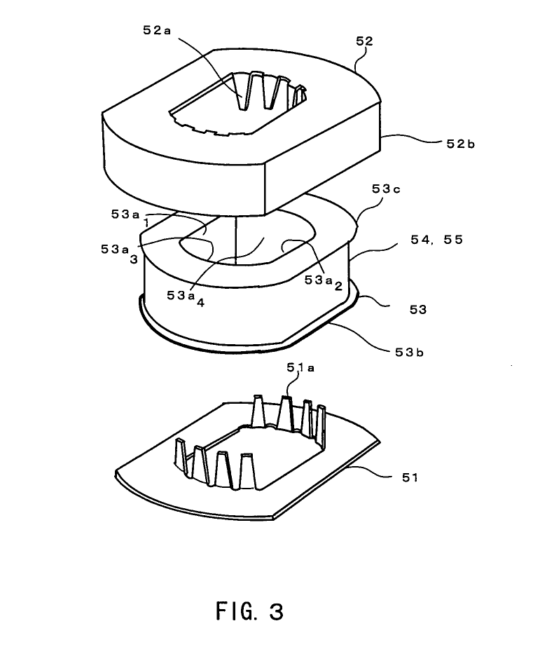

Referring to FIG. 3, the first yoke 51 is punched out of a soft magnetic steel plate, and has an opening at its center corresponding to the hollow of the bobbin 53. The opening of the first yoke 51 in the figure is shaped oval, or may alternatively be shaped circular, and the rotor assembly 40 is inserted through the opening of the first yoke 51. Four pole teeth 51a are formed respectively at two portions of the inner circumference of the first yoke 51 corresponding to the third and fourth walls 53a₃ and 53a₄ and are bent up toward the second yoke 52 so as to be inserted through the hollow of the bobbin 53 thus opposing the magnetic poles 42 of the rotor assembly 40. The first yoke 51 has an outer configuration similar to that of the first and second flanges 53b and 53c of the bobbin 53.

The second yoke 52 is punched out of a soft magnetic steel plate, and has an opening at its center corresponding to the hollow of the bobbin 53. The opening of the second yoke 52, like that of the first yoke 51, is shaped oval as shown in FIG. 3, or may alternatively be shaped circular, and the rotor assembly 40 is inserted through the opening of the second yoke 52. Four pole teeth 52a are formed respectively at two portions of the inner circumference of the second yoke 52 corresponding to the third and fourth walls 53a₃ and 53a₄ and are bent up toward the first yoke 51 so as to be inserted through the hollow of the bobbin 53 and to intermesh with the pole teeth 51a of the first yoke 51 thus opposing the magnetic poles 42 of the rotor assembly 40. An outer rim portion 52b of the second yoke 52 is bent, for example by drawing, toward the first yoke 51 so as to engage with an outer circumference of the first yoke 51, and functions as a magnetic path to magnetically connect the first and second yokes 51 and 52. The second yoke 52 has an outer configuration similar to that of the first and second flanges 53b and 53c of the bobbin 53. The pole teeth 52a of the second yoke 52 are shifted in phase by 180 degrees from the pole teeth 51a of the first yoke 51.

Referring back to FIG. 1, the stator unit 60 is composed of first and second yokes 61 and 62 disposed to oppose each other, and a magnet wire 64 (identical with the magnet wire 54) wound around a bobbin 63 (identical with the bobbin 53) sandwiched between the first and second yokes 61 and 62, and an insulator 65 (identical with the insulator 55) is disposed around the magnet wire 64. The first yokes 61 and 62 are structured identically with the first and second yokes 51 and 52 of the stator unit 50, and have respective pole teeth 61a and 62a.

The first yoke 51 of the stator unit 50 and the first yoke 61 of the stator unit 60 are coaxially welded to each other. A front plate 71 is attached to the second yoke 52, and a front bearing 72 to rotatably support the rotary shaft 41 is attached to the front plate 71. A rear plate 73 is attached to the second yoke 62, and a rear bearing 74 to support rotatably the rotary shaft 41 is attached to the rear plate 73.

In the stepping motor structured as above, when the magnet wire 54 disposed between the first and second yokes 51 and 52 is supplied with electricity, the pole teeth 51a and 52a are magnetized, whereby attraction and repulsion are generated against the magnetic poles 42 of the rotor assembly 40. Also, when the magnet wire 64 disposed between the first and second yokes 61 and 62 is supplied with electricity, the pole teeth 61a and 62a are magnetized, whereby attraction and repulsion are generated against the magnetic poles 42 of the rotor assembly 40. The attraction and repulsion thus generated cause the rotor assembly 40 to rotate.

Next, an advantage of this stepping motor will be explained.

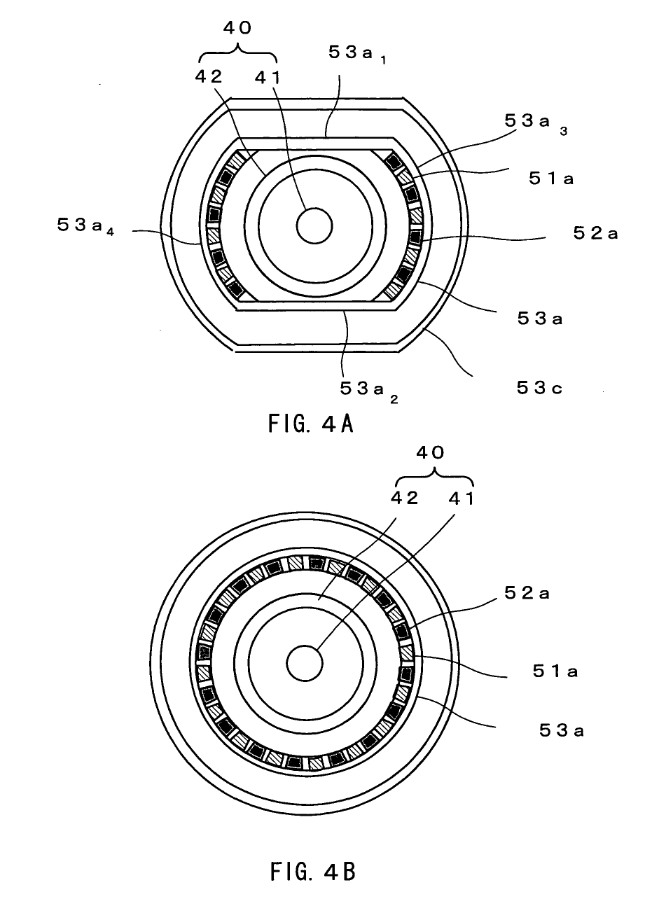

In a case where the pole teeth 51a of the yoke 51 and the pole teeth 52a of the yoke 52 are formed everywhere along a circular hole as conventional, the body section 53a of the bobbin 53 has to be circular-cylindrical as shown in FIG. 4B.

On the other hand, according to the above-described embodiment, since the pole teeth 51a and 52a of the yokes 51 and 52 are formed only at the portions corresponding to the walls 51a₃ and 53a₄ of the bobbin 53 and not at the portions corresponding to the walls 53a₁ and 53a₂ as shown in FIG. 4A, the yokes 51 and 52 can be formed oval, and the body section 53a of the bobbin 53 can be shaped oval-cylindrical.

When the body section 53a of the bobbin 53 is shaped oval-cylindrical as described above, the dimension between the first and second walls 53a₁ and 53a₂ can be reduced, and accordingly the flanges 53b and 53c can be shaped with a reduced dimension therebetween, which allows the number of turns for the magnet wire 54 to be increased to such an extent as to ensure the torque characteristic conventionally achieved while realizing dimensional reduction.

The present invention is not limited to the embodiment described above but may alternatively be embodied as follows.

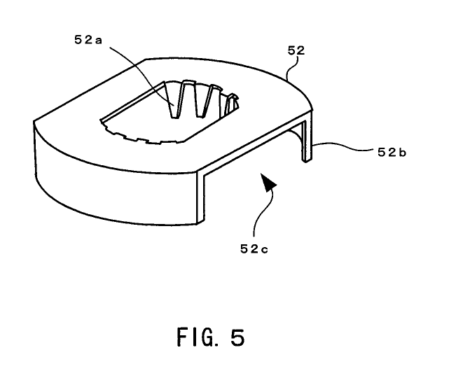

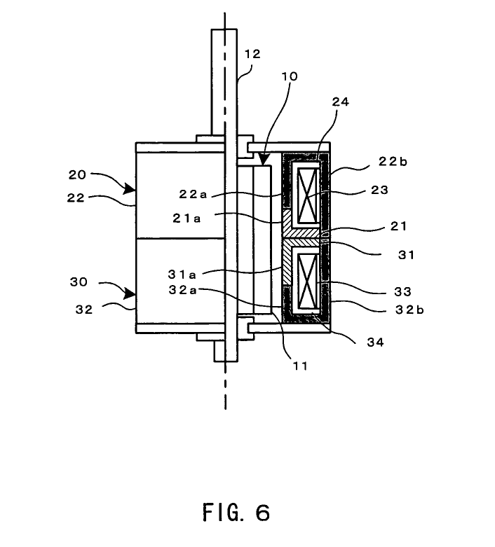

(1) The numbers of the pole teeth 51a, 52a, 61a and 62a may be changed according to angular resolution of the stepping motor. And, all the pole teeth do not necessarily have a complete shape as shown in FIGS. 3 and 5 (symmetric trapezoid in the figures), but alternatively some thereof may be half-formed, which may be defined by, for example, (4+½).

(2) The present invention may be applied to a stepping motor of single-phase or three or more-phase driving, instead of two-phase driving.

(3) The second yoke 52 may be modified, for example, as shown in FIG. 5, where the bent outer rim portion 52b thereof is interrupted by two voids 52c (only one is shown in the figure) to be separated into two sections such that the magnet wire 54 wound around the bobbin 53, and the insulator 55 are not entirely covered, while the bent outer rims portion 52b in the embodiment described above is uninterrupted so as to entirely cover the magnet wire 54 and the insulator 55. This modification can be applied when the motor is used in an environment free from exterior force, and can contribute to further downsizing, reduction in weight, and efficient heat dissipation. Also, this enables the outer rim portion 52b sectioned into two to be bent without drawing process thus making the bending work easier.

The scope of the invention is, therefore, indicated by the appended claims rather than by the foregoing description. All changes that come within the meaning and range of equivalency of the claims are to be embraced within their scope.

This application is based on Japanese Patent Application No. 2003-278652 filed on Jul. 23, 2003 and including specification, claims, drawings and summary. The disclosure of the above Japanese Patent Application is incorporated herein by reference in its entirety.

1. A bobbin comprising:
a) a body section shaped hollow-cylindrical, having a predetermined length, and composed of
a first wall formed of a flat rectangular plate,
a second wall formed of a flat rectangular plate, and disposed to oppose the first wall in parallel,
a third wall formed of a rectangular plate curved circumferentially outward, and having its both ends connected respectively to one end of the first wall and one end of the second wall, and
a fourth wall formed of a rectangular plate curved circumferentially outward, disposed to symmetrically oppose the third wall, and having its both ends connected respectively to other end of the first wall and other end of the second wall;
b) a first flange disposed at one end of the body section so as to extend perpendicularly to the walls for a substantially uniform dimension; and
c) a second flange disposed at other end of the body section so as to extend perpendicularly to the walls for a substantially uniform dimension.

2. A bobbin according to claim 1, wherein the third and fourth walls of the body section have a circular arc radial cross-section, and wherein a distance between the first and second walls is smaller than a distance between the third and fourth walls.

3. A motor comprising
a) a rotor assembly shaped cylindrical, and having a ring magnet disposed at its outer circumference and provided with a predetermined number of magnetic poles, and a rotary shaft fixedly inserted through its center,
b) a stator assembly having
a bobbin including
a body section shaped hollow-cylindrical, having a predetermined length, and composed of: a first wall formed of a flat rectangular plate; a second wall formed of a flat rectangular plate, and disposed to oppose the first wall in parallel; a third wall formed of a rectangular plate curved circumferentially outward, and having its both ends connected respectively to one end of the first wall and one end of the second wall; and a fourth wall formed of a rectangular plate curved circumferentially outward, disposed to symmetrically oppose the third wall, and having its both ends connected respectively to other end of the first wall and other end of the second wall,
a first flange disposed at one end of the body section so as to extend perpendicularly to the walls for a substantially uniform dimension, and
a second flange disposed at other end of the body section so as to extend perpendicularly to the walls for a substantially uniform dimension,
a magnet wire wound around the body section of the bobbin,
first yoke made of a soft magnetic steel plate, having at a center thereof an opening which defines an inner circumference of the first yoke, has a dimension larger than a diameter of the rotor assembly, corresponds to a hollow of the bobbin, and in which the rotor assembly is inserted, the first yoke having a plurality of pole teeth formed along the inner circumference thereof respectively at two portions corresponding to the third and fourth walls of the bobbin, the plurality of pole teeth being inserted in the hollow of the bobbin so as to oppose the magnetic poles of the rotor assembly,
a second yoke made of a soft magnetic steel plate, disposed to oppose the first yoke so as to sandwich the bobbin therebetween, and having at a center thereof an opening which defines an inner circumference of the second yoke, has a dimension larger than the diameter of the rotor assembly, corresponds to the hollow of the bobbin, and in which the rotor assembly is inserted, the second yoke having a plurality of pole teeth formed along the inner circumference thereof respectively at two portions corresponding to the third and fourth walls of the bobbin, the plurality of pole teeth being inserted in the hollow of the bobbin so as to oppose the magnetic poles of the rotor assembly, and
a magnetic path means to magnetically connect the first and second yokes, and
c) bearing means to rotatably support the rotary shaft of the rotor assembly such that a predetermined gap is kept between the magnetic poles of the rotor assembly and the pole teeth of the first and second yokes.

4. A motor according to claim 3, wherein the third and fourth walls of the body section of the bobbin have a circular arc radial cross-section, and wherein a distance between the first and second walls is smaller than a distance between the third and fourth walls.

5. A motor according to claim 3, wherein the stator assembly is composed of a plurality of stator units each constituted by the bobbin, the magnet wire, the first and second yokes, and the magnetic path means.
